(19) United States
(12) Patent Application Publication
(10) Pub. No.: US 2019/0141955 A1
(43) Pub. Date: May 16, 2019

(54) ROBOTIC PET WALKER

(71) Applicant: Dharmesh Dharmesh, Plainsboro, NJ (US)

(72) Inventor: Dharmesh Dharmesh, Plainsboro, NJ (US)

(21) Appl. No.: 16/189,620

(22) Filed: Nov. 13, 2018

Related U.S. Application Data
(60) Provisional application No. 62/585,201, filed on Nov. 13, 2017.

(51) Int. Cl. A01K 15/02; A01K 27/00; B62D 55/12; G05D 1/02; E01H 1/00

(52) U.S. Cl. CPC A01K 15/027; A01K 27/005; A01K 15/025; H04B 1/38; G05D 1/0278; E01H 1/006; B62D 55/12

(57) ABSTRACT

Generally speaking, robotic pet walker is a self propelled apparatus for walking and entertaining canine pets in the absence of its owner. The robotic pet walker is able to travel programmed travel routes, dispense treats, scoop waste, and interactively play fetch autonomously or by control of the pet owner via internet and GPS. An LCD screen can display live video of the pet owner and a speaker can broadcast the voice of the owner to interact with the pet.

### CROSS-REFERENCE TO RELATED APPLICATION

The present application is related to and claims priority from prior provisional application Ser. No. 62/585,201, filed Nov. 13, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pet tending devices and more specifically relates to a robotic pet walker.

### 2. Description of the Related Art

Millions of families have pets that are treated as members of the family. These pets enjoy a life of interaction with children and adult family members that greatly enhances the relationship for both the pet and the family members. Pets do tend to need frequent contact and interaction because they are very similar to humans in that respect. This can be a problem when the family has gone somewhere that they are not able to take the pet. When the duration of these solitary periods becomes extended, the family is not able to care for the pet optimally. The pet can become lonesome and need other activities to help pass the time.

At other times when the family is home, it can be inconvenient to tend to the pet, such as late at night in freezing cold temperatures when the pet needs to go out. Leaving the warmth of the inside of the home for even a short duration when the temperatures are freezing is not something that anyone really likes to do, but the pets often do not seem to mind it. An innovation that could provide some solutions to these problems is needed.

Various attempts have been made to solve the above-mentioned problems such as those found in U.S. Pat. No. 9,226,477 to Andrew Peter Davis; U.S. Publication No. 9737049 to Trotier et al.; U.S. Patent No. 20040194714 to Ji-hong Lee; U.S. Patent No. 20110139076 to Pu et al; and U.S. Pat. No. 5,299,529 to Peter Ramirez. This art is representative of communication and/or automatic feeding devices. None of the above inventions and patents, taken either singly or in combination, is seen to describe the invention as claimed.

Ideally, a pet tending device should provide for all of the pets basic needs and entertainment, and yet, would operate reliably and be manufactured at a modest expense. Thus, a need exists for a reliable robotic pet walker to avoid the above-mentioned problems.

### BRIEF SUMMARY OF THE INVENTION

In view of the foregoing disadvantages inherent in the known pet tending device art, the present invention provides a novel robotic pet walker. The general purpose of the present invention, which will be described subsequently in greater detail, is to provide an apparatus that will supply all of the pets basic needs and entertainment.

A robotic pet walker preferably comprises a rectangular box including an outer shell forming an inner volume, a plurality of spindles rotatably connected to the rectangular box, a plurality of wheels connected to opposite ends of the plurality of spindles thereby forming left wheels and right wheels that are located outside of the inner volume and are adapted to be rotated on the plurality of spindles, a left track connected to the left wheels, a right track connected to the right wheels, a motor located within the inner volume that is adapted to rotate the plurality of spindles and thereby the plurality of wheels, a computer member located within the inner volume that is electrically connected and adapted to control the motor and is thereby adapted to control the wheels to thereby control the movement of the robotic pet walker, a transceiver located within the inner volume that is electrically connected to the computer member that is adapted to send and receive electronic signals to and from the computer member and to and from an external electronic system that includes a GPS system such that the robotic pet walker can be controlled remotely and such that the robotic pet walker can move autonomously, a pet leash attachment attached to the outer surface of the outer shell that is adapted to releasably hold a pet leash thereto so that a pet can be releasably attached to the robotic pet walker via the pet leash and be walked by the robotic pet walker.

A power source located within the inner volume is electrically connected to the motor and to the computer member. At least one camera is attached to an outer surface of the outer shell and is electronically connected to the power source and to the computer member. At least one microphone is attached to the outer surface of the outer shell and is electronically connected to the power source and the computer member. At least one speaker is attached to the outer surface of the outer shell that is electronically connected to the power source and to the computer member.

A scoop is mechanically connected to the rectangular box and electrically connected to the power source and to the computer member to scoop up waste from the pet during the walk, and the camera is adapted to allow the computer member to detect waste deposited by the pet and control the scoop to scoop up and hold the waste for disposal.

At least one light is attached to the outer surface of the outer shell that is electronically connected to the power source and the computer member for use after dark. An electronic screen attached to the outer surface of the outer shell is electronically connected to the power source and the computer member to emit electronic images therefrom. The electronic screen is preferably formed as an LCD screen.

At least one gear mechanism is operably connected between the plurality of wheels and the plurality of spindles to thereby allow control of the direction of rotation of each of the wheels to thereby allow the robotic pet walker to turn in various directions. The motor is preferably formed as an electric motor.

A treat dispenser is mechanically connected to the rectangular box and electrically connected to the power source and the computer member to retain and dispose treats therefrom. A toy dispenser is mechanically connected to the rectangular box and electrically connected to the power source and to the computer member and adapted to retain and dispose toys therefrom. The toys are chosen from a group of toys consisting of a ball and a FRISBEE. A ball throwing mechanism is mechanically connected to the rectangular box and electrically connected to the power source and to the computer member that is adapted to throw a ball therefrom. A FRISBEE throwing mechanism is also mechanically connected to the rectangular box and electrically connected to the power source and the computer member that is adapted to throw a FRISBEE therefrom.

A brush mechanism is mechanically connected to the rectangular box and electrically connected to the power source and the computer member to brush waste into the scoop for aiding the removal of waste deposited by the pet.

The computer member is encoded with software that is adapted to be programmed with predetermined walking routes and pet exercise routines and is adapted to be programmed remotely via an external computer member. A phone SIM card holder is attached to the outer surface of the outer shell that is electronically connected to the power source and to the computer member for storing information and providing information therefrom.

The present invention holds significant improvements and serves as a robotic pet walker. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a robotic pet walker, constructed and operative according to the teachings of the present invention.

FIG. 1 shows a side view illustrating an in-use condition of a robotic pet walker according to an embodiment of the present invention.

FIG. 2 is a side view illustrating the robotic pet walker according to an embodiment of the present invention of FIG. 1.

FIG. 3 is a side view illustrating operating components of the robotic pet walker according to an embodiment of the present invention of FIG. 1.

FIG. 4 is a rear view illustrating robotic pet walker according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a pet tending device and more particularly to a robotic pet walker as used to supply all of a pet's basic needs and entertainment.

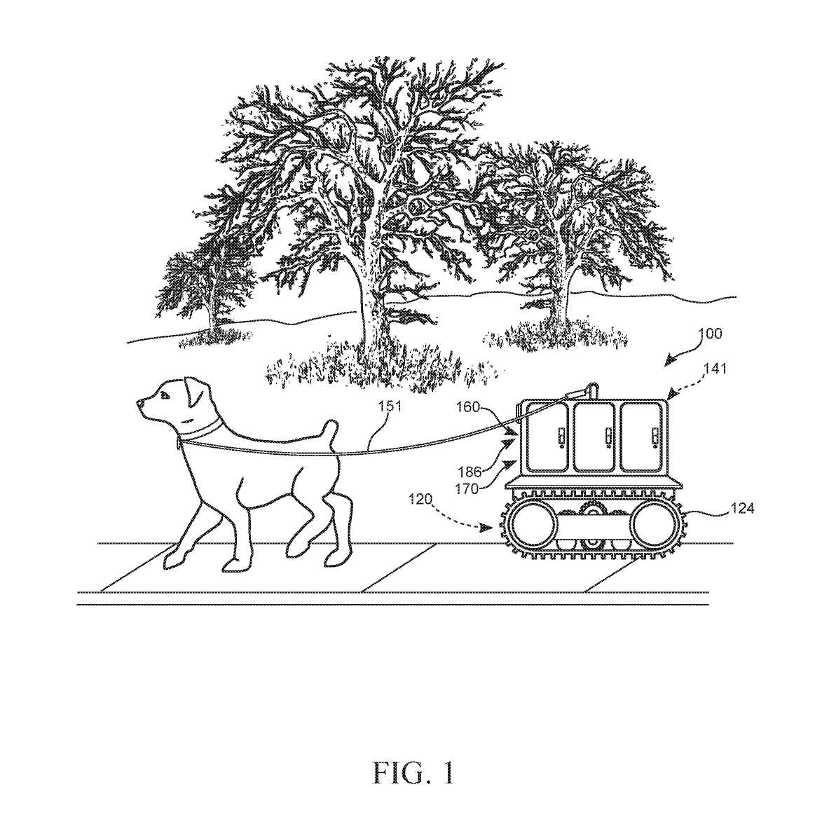

Referring to the drawings by numerals of reference there is shown in FIG. 1, a side view illustrating an in-use condition of robotic pet walker 100 according to an embodiment of the present invention.

Robotic pet walker 100 is a self propelled apparatus for walking and entertaining canine pets in the absence of the pet's owner. Robotic pet walker 100 is able to travel programmed travel routes, dispense treats, scoop waste, and interactively play fetch autonomously or by control of the pet owner via internet and GPS system 141 while the pet owner is remotely located. The pet owner often must go places that the pet cannot feasible go and so this provides a method of interaction for the pet as though the owner was with the pet. LCD screen 186 can display live video of the pet owner to simulate the owner's presence and speaker 170 can broadcast the voice of the owner to interact with the pet. Camera 160 lens located on the exterior of the outer shell gives the pet owner a view of the surrounding area as well as any special conditions the owner should be aware of. Robotic pet walker 100 has tracks 124 for traversing rough terrain or terrain having sandy or a soft ground surface that wheels 120 could get stuck in. A system having a set of wheels 120 located inside tracks 124 is able to extend downward thereby lifting robotic pet walker 100 in order to travel at faster speeds, such as on roadways, smooth flat pathways, or sidewalks, in order to exercise the pet or to get to a second location quicker than tracks 124 are able to allow robotic pet walker 100 to travel.

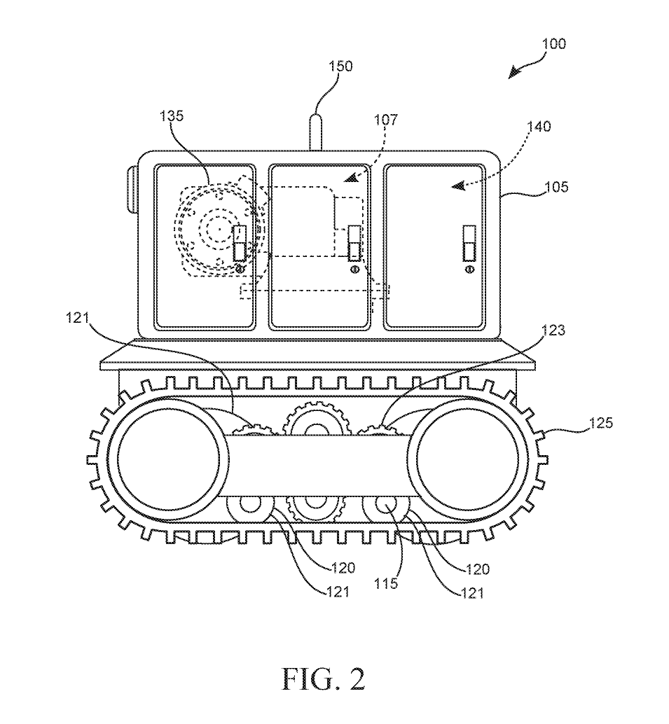

Referring now to FIG. 2, a side view illustrating robotic pet walker 100 according to an embodiment of the present invention of FIG. 1.

At least one gear mechanism 123 is operably connected between the plurality of wheels 120 and the plurality of spindles 115 to thereby allow control of the direction of rotation of each of wheels 120 to thereby allow robotic pet walker 100 to turn in various directions. Motor 135 is preferably formed as an electric motor 135.

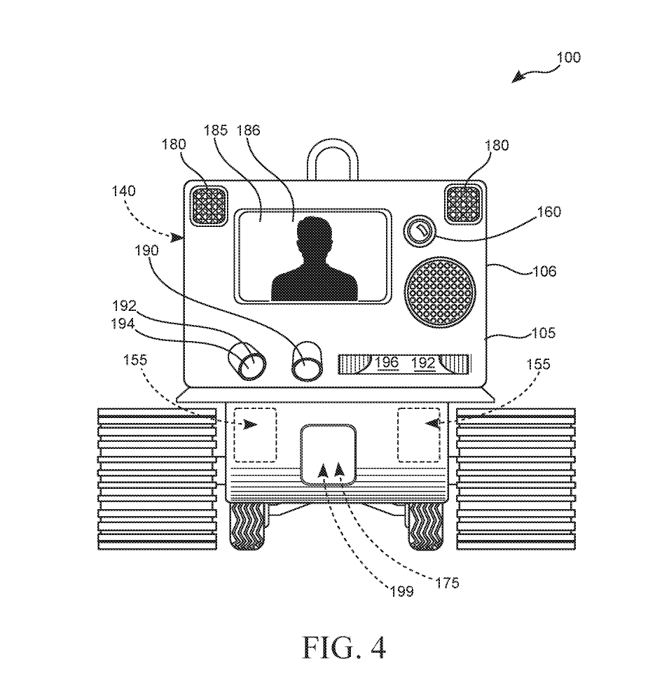

Robotic pet walker 100 preferably comprises rectangular box 105 including outer shell 106 forming inner volume 107, a plurality of spindles 115 rotatably connected to rectangular box 105, a plurality of wheels 120 connected to opposite ends of the plurality of spindles 115 thereby forming left wheels 121 and right wheels 122 (shown in FIG. 4) that are located outside of inner volume 107 and are adapted to be rotated on the plurality of spindles 115, left track 125 connected to left wheels 121, right track 130 (shown in FIG. 4) connected to right wheels 122 (shown in FIG. 4), motor 135 located within inner volume 107 that is adapted to rotate the plurality of spindles 115 and thereby the plurality of wheels 120, computer member 140 located within inner volume 107 that is electrically connected and adapted to control motor 135 and is thereby adapted to control wheels 120 to thereby control the movement of robotic pet walker 100, transceiver 145 (shown in FIG. 4) located within inner volume 107 that is electrically connected to computer member 140 that is adapted to send and receive electronic signals to and from computer member 140 and to and from an external electronic system that includes GPS system 141 (shown in FIG. 4) such that robotic pet walker 100 can be controlled remotely and such that robotic pet walker 100 can move autonomously, pet leash attachment 150 attached to the outer surface of outer shell 106 that is adapted to releasably hold pet leash 151 (shown in FIG. 1) thereto so that a pet can be releasably attached to robotic pet walker 100 via pet leash 151 and be walked by robotic pet walker 100.

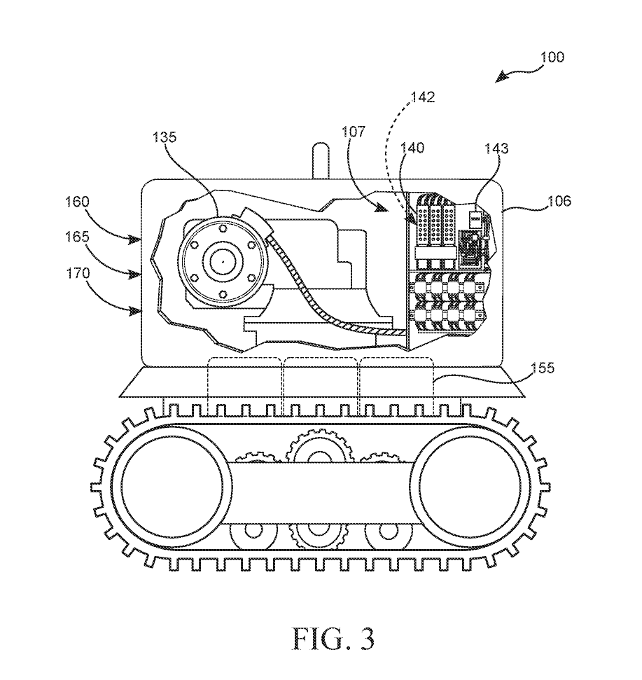

Referring now to FIG. 3, a side view illustrating operating components of robotic pet walker 100 according to an embodiment of the present invention of FIG. 1.

Power source 155 located within inner volume 107 is electrically connected to motor 135 and to computer member 140. At least one camera 160 is attached to the outer surface of outer shell 106 and is electronically connected to power source 155 and to computer member 140. At least one microphone 165 is attached to the outer surface of outer shell 106 and is electronically connected to power source 155 and computer member 140. At least one speaker 170 is attached to the outer surface of outer shell 106 that is electronically connected to power source 155 and to computer member 140.

Computer member 140 is encoded with software 142 that is adapted to be programmed with predetermined walking routes and pet exercise routines and is adapted to be programmed remotely via an external computer member. Phone SIM card holder 143 is attached to the outer surface of outer shell 106 that is electronically connected to power source 155 and to computer member 140 for storing information and providing information therefrom.

Referring now to FIG. 4, is a rear view illustrating robotic pet walker 100 according to an embodiment of the present invention of FIG. 1.

Scoop 175 is mechanically connected to rectangular box 105 and electrically connected to power source 155 and to computer member 140 to scoop up waste from the pet during the walk, and camera 160 is adapted to allow computer member 140 to detect waste deposited by the pet and control scoop 175 to scoop up and hold the waste for disposal.

At least one light 180 is attached to the outer surface of outer shell 106 that is electronically connected to power source 155 and computer member 140 for use after dark. Electronic screen 185 attached to the outer surface of outer shell 106 is electronically connected to power source 155 and computer member 140 to emit electronic images therefrom. Electronic screen 185 is preferably formed as LCD screen 186.

Treat dispenser 190 is mechanically connected to rectangular box 105 and electrically connected to power source 155 and computer member 140 to retain and dispose treats therefrom. Toy dispenser 192 is mechanically connected to rectangular box 105 and electrically connected to power source 155 and to computer member 140 and adapted to retain and dispose toys therefrom. The toys are chosen from a group of toys consisting of a ball and a FRISBEE. Ball throwing mechanism 194 is mechanically connected to rectangular box 105 and electrically connected to power source 155 and to computer member 140 that is adapted to throw a ball therefrom. FRISBEE throwing mechanism 196 is also mechanically connected to rectangular box 105 and electrically connected to power source 155 and computer member 140 that is adapted to throw a FRISBEE therefrom.

Brush mechanism 199 is mechanically connected to rectangular box 105 and electrically connected to power source 155 and computer member 140 to brush waste into scoop 175 for aiding the removal of waste deposited by the pet.

Robotic pet walker 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A robotic pet walker comprising:
a rectangular box including:
an outer shell forming an inner volume;
a plurality of spindles;
wherein said plurality of spindles are rotatably connected to said rectangular box;
a plurality of wheels;
wherein said plurality of wheels are connected to opposite ends of respective said plurality of spindles thereby forming left wheels and right wheels, are located outside of said inner volume, and are adapted to be rotated via said plurality of spindles;
a left track;
wherein said left track is connected to said left wheels;
a right track;
wherein said right track is connected to said right wheels;
a motor;
wherein said motor is located within said inner volume and is adapted to rotate said plurality of spindles and thereby said plurality of wheels;
a computer member;
wherein said computer member is located within said inner volume, is electrically connected to and adapted to control said motor, and is thereby adapted to control said wheels to thereby control the movement of said robotic pet walker;
a transceiver;
wherein said transceiver is located within said inner volume, is electrically connected to said computer member, and is adapted to send and receive electronic signals to and from said computer member and to and from an external electronic system, including a GPS system, such that said robotic pet walker can be controlled remotely, and such that said robotic pet walker can move autonomously;
a pet leash attachment;
wherein said pet leash attachment is attached to an outer surface of said outer shell and is adapted to releasably hold a pet leash thereto;
wherein a pet can be releasably attached to said robotic pet walker via said pet leash and be walked by said robotic pet walker.

2. The pet servicing device of claim 1, further comprising a power source located within said inner volume and is electrically connected to said motor and said computer member.

3. The pet servicing device of claim 2, further comprising at least one camera attached to an outer surface of said outer shell and is electronically connected to said power source and said computer member.

4. The pet servicing device of claim 2, further comprising at least one microphone attached to an outer surface of said outer shell and is electronically connected to said power source and said computer member.

5. The pet servicing device of claim 2, further comprising and at least one speaker attached to an outer surface of said outer shell and is electronically connected to said power source and said computer member.

6. The pet servicing device of claim 3, further comprising a scoop mechanically connected to said rectangular box, electrically connected to said power source and said computer member, and is adapted to scoop up waste from said pet during said walk; and wherein said camera is adapted to allow said computer member to detect waste deposited by said pet and control said scoop to scoop up and hold said waste for disposal.

7. The pet servicing device of claim 2, further comprising at least one light attached to an outer surface of said outer shell and is electronically connected to said power source and said computer member.

8. The pet servicing device of claim 2, further comprising an electronic screen attached to an outer surface of said outer shell, is electronically connected to said power source and said computer member, and is adapted to emit electronic images therefrom.

9. The pet servicing device of claim 2, wherein said electronic screen is formed as an LCD screen.

10. The pet servicing device of claim 2, further comprising at least one gear mechanism connected between respective said plurality of wheels and said plurality of spindles to thereby allow control of the direction of rotation of each of said plurality of wheels to thereby allow said robotic pet walker to turn in various directions.

11. The pet servicing device of claim 2, wherein said motor is formed as an electric motor.

12. The pet servicing device of claim 2, further comprising a treat dispenser mechanically connected to said rectangular box, electrically connected to said power source and said computer member, and is adapted to retain and dispose treats therefrom.

13. The pet servicing device of claim 2, further comprising a toy dispenser mechanically connected to said rectangular box, electrically connected to said power source and said computer member, and is adapted to retain and dispose toys therefrom.

14. The pet servicing device of claim 2, wherein said toys are chosen from a group of toys consisting of a ball and frisbee.

15. The pet servicing device of claim 2, further comprising a ball throwing mechanism mechanically connected to said rectangular box, electrically connected to said power source and said computer member, and is adapted to throw a ball therefrom.

16. The pet servicing device of claim 2, further comprising a frisbee throwing mechanism mechanically connected to said rectangular box, electrically connected to said power source and said computer member, and is adapted to throw a ball therefrom.

17. The pet servicing device of claim 6, further comprising a brush mechanism mechanically connected to said rectangular box, electrically connected to said power source and said computer member, and is adapted to brush waste into said scoop for aiding and removing said waste.

18. The pet servicing device of claim 1, wherein said computer member is encoded with software adapted to be programmed with predetermined walking routes and pet exercise routines.

19. The pet servicing device of claim 18, wherein said computer member is adapted to be programmed remotely via an external computer member.

20. The pet servicing device of claim 2, further comprising a phone SIM card holder attached to an outer surface of said outer shell, is electronically connected to said power source and said computer member, and is adapted to receive a phone SIM card therein for storing information and providing information therefrom.
